(19) United States
(12) Patent Application Publication
(10) Pub. No.: US 2005/0191178 A1
(43) Pub. Date: Sep. 1, 2005

(54) Assembly including an electric motor and a load

(75) Inventors: William James Watkins, Tipp City, OH (US); Chih Min Lin, Tipp City, OH (US)

Correspondence Address: MICHAEL BEST & FRIEDRICH, LLP, 100 E WISCONSIN AVENUE, MILWAUKEE, WI, 53202, US

(73) Assignee: A.O. Smith Corporation, Milwaukee, WI (US)

(21) Appl. No.: 10/788,092

(22) Filed: Feb. 26, 2004

(51) Int. Cl. F03B 1/02

(52) U.S. Cl. 415/216.1

(57) ABSTRACT

An assembly including an electric motor, a load, and a retainer. The electric motor can include a shaft that defines a first cross-section that is non-circular and substantially normal to the shaft axis. The load can include a rotating member that defines a bore and first and second apertures in communication with the bore. The bore can be configured to receive at least a portion of the shaft. An opening of the bore can be fully enclosed by a continuous portion of the rotating member. A portion of the bore can define a second cross-section that is non-circular and that corresponds to at least a portion of the first cross-section. The retainer can extend through the first and second apertures and engage the shaft and thereby substantially prevent axial movement of the shaft relative to the rotating member during normal operation of the electric motor.

### BACKGROUND OF THE INVENTION

The invention relates to connection of electric motors to loads.

Various means have been utilized to connect electric motors to loads (e.g., fluid pumps, blowers, and the like). Nevertheless, a new connection that provides ease of manufacturing, installation, and maintenance would be welcomed by those in the art.

### SUMMARY OF THE INVENTION

Shafts of electric motors are typically drivingly connected to a fluid pump impeller using a threaded connection. Thread tapping the motor shaft and the impeller is a costly secondary operation. Further, when molded plastic impellers are utilized, a threaded brass insert must be connected to the impeller to receive the threaded motor shaft. Although the threads are tapped to avoid loosening during rotation of the impeller in the intended direction, the motor may rotate the impeller in the opposite direction in some instances. Reverse rotation of a standard threaded connection may result in disengagement of the drive shaft from the impeller unless a means of retaining the drive shaft on the impeller exists.

In one construction, the invention provides an assembly including an electric motor, a load, and a retainer. The electric motor can include a housing, a stator fixed relative to the housing, a shaft supported by the housing for rotation about a shaft axis, and a rotor connected to the shaft for rotation therewith relative to the stator. A portion of the shaft can define a first cross-section that is non-circular and substantially normal to the shaft axis. The load can include a housing and a rotating member configured to be driven by the electric motor for rotation relative to the housing. The rotating member can define a bore and first and second apertures in communication with the bore. The bore can be configured to receive at least a portion of the shaft. An opening of the bore can be fully enclosed by a continuous portion of the rotating member. A portion of the bore can define a second cross-section that is non-circular and that corresponds to at least a portion of the first cross-section. The retainer can extend through the first and second apertures and engage the shaft and thereby substantially prevent axial movement of the shaft relative to the rotating member during normal operation of the electric motor.

In another construction, the invention provides a method of drivingly connecting an electric motor to a rotating member. The method can include providing an electric motor, a rotating member, and a resilient lock member. The electric motor can include a stator, a shaft supported for rotation about a shaft axis, and a rotor connected to the shaft for rotation therewith relative to the stator. A portion of the shaft can define a first cross-section that is non-circular and substantially normal to the shaft axis. The shaft can also define a groove. The rotating member can be configured to be driven by the electric motor. The rotating member can define a bore and first and second apertures in communication with the bore. The bore can be configured to receive at least a portion of the shaft. An opening of the bore can be fully enclosed by a continuous portion of the rotating member. A portion of the bore can define a second cross-section that is non-circular and configured to engage at least a portion of the shaft that defines the first cross-section. The method can also include inserting the shaft into the bore so the groove is at least partially axially aligned with the first and second apertures, and deflecting the resilient lock member relative to the rotating member so the resilient lock member engages the groove through the first and second apertures.

In yet another construction, the invention provides an assembly including an electric motor, a fluid pump, and a retaining member. The electric motor can include a housing, a stator fixed relative to the housing, a motor shaft supported by the housing for rotation about a shaft axis, and a rotor connected to the motor shaft for rotation with the motor shaft relative to the stator. A portion of the motor shaft can define a first cross-section that is non-circular and substantially normal to the shaft axis. The motor shaft can define a groove. The fluid pump can include a housing and a molded plastic impeller configured to be driven by the electric motor for rotation relative to the housing. The impeller can include a hollow shaft that defines a bore and first and second apertures in communication with the bore. The bore can be configured to receive at least a portion of the motor shaft. An opening of the bore can be fully enclosed by a continuous portion of the hollow shaft. A portion of the bore can define a second cross-section that is non-circular. The portion of the bore that defines the second cross-section can be configured to engage at least a portion of the shaft that defines the first cross-section. The retaining member can extend through the first and second apertures and engage the groove and thereby substantially prevent axial movement of the motor shaft relative to the hollow shaft during normal operation of the electric motor.

Further aspects of the invention together with the organization and manner of operation thereof, will become apparent from the following detailed description of the invention when taken in conjunction with the accompanying drawings wherein like elements have like numerals throughout the drawings.

### BRIEF DESCRIPTION OF THE DRAWINGS

The invention is further described with reference to the accompanying drawings, which show constructions of the invention. However, it should be noted that the invention as disclosed in the accompanying drawings is illustrated by way of example only. The various elements and combinations of elements described below and illustrated in the drawings can be arranged and organized differently to result in constructions which are still within the spirit and scope of the invention. Also, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” are used broadly and encompass both direct and indirect mountings, connections, supports, and couplings. Further, “connected” and “coupled” are not restricted to physical or mechanical connections or couplings.

FIG. 1 is a perspective view of an assembly according to a first construction of the invention.

FIG. 2 is a side view of the assembly illustrated in FIG. 1.

FIG. 3 is an exploded view of a portion of the assembly illustrated in FIG. 1.

FIG. 4 is a view similar to FIG. 3 showing alternative constructions of the motor shaft and the impeller.

FIG. 5 is a sectional view of a portion of the assembly illustrated in FIG. 1 taken along line 5-5 in FIG. 2.

FIG. 6 is a sectional view of a portion of the assembly illustrated in FIG. 1 taken along line 6-6 in FIG. 2.

FIG. 7 is a sectional view of a portion of the assembly illustrated in FIG. 1 taken along line 7-7 in FIG. 5.

FIG. 8 is a sectional view of a portion of the assembly illustrated in FIG. 1 taken along line 8-8 in FIG. 2.

FIG. 9 is a perspective view of an assembly according to a second construction of the invention.

FIG. 10 is a side view of the assembly illustrated in FIG. 9.

FIG. 11 is an exploded view of a portion of the assembly illustrated in FIG. 9.

FIG. 12 is a perspective view of an alternative construction of a retainer member for use with the assembly illustrated in FIG. 9.

FIG. 13 is a sectional view of a portion of the assembly illustrated in FIG. 9 taken along line 13-13 in FIG. 10.

FIG. 14 is a sectional view of a portion of the assembly illustrated in FIG. 9 taken along line 14-14 in FIG. 10.

FIG. 15 is a sectional view of a portion of the assembly illustrated in FIG. 9 taken along line 15-15 in FIG. 13.

FIG. 16 is a sectional view of a portion of the assembly illustrated in FIG. 9 taken along line 16-16 in FIG. 10.

### DETAILED DESCRIPTION

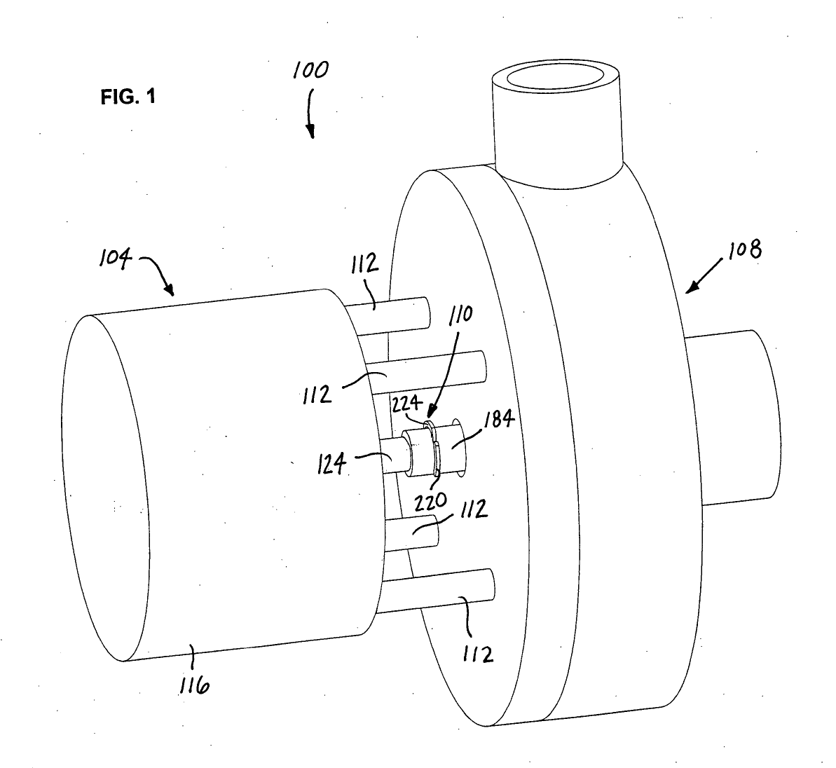

An assembly 100 according to a first construction of the invention is illustrated in FIG. 1-3 and 5-8. With reference to FIG. 1, the assembly 100 includes an electric motor 104, a load 108, and a retainer or lock member 110 for use in drivingly connected the motor 104 to the load 108. As illustrated in FIG. 1, the motor 104 can be spaced from the load 108 by spacer legs 112, as is typical for light duty pump assemblies.

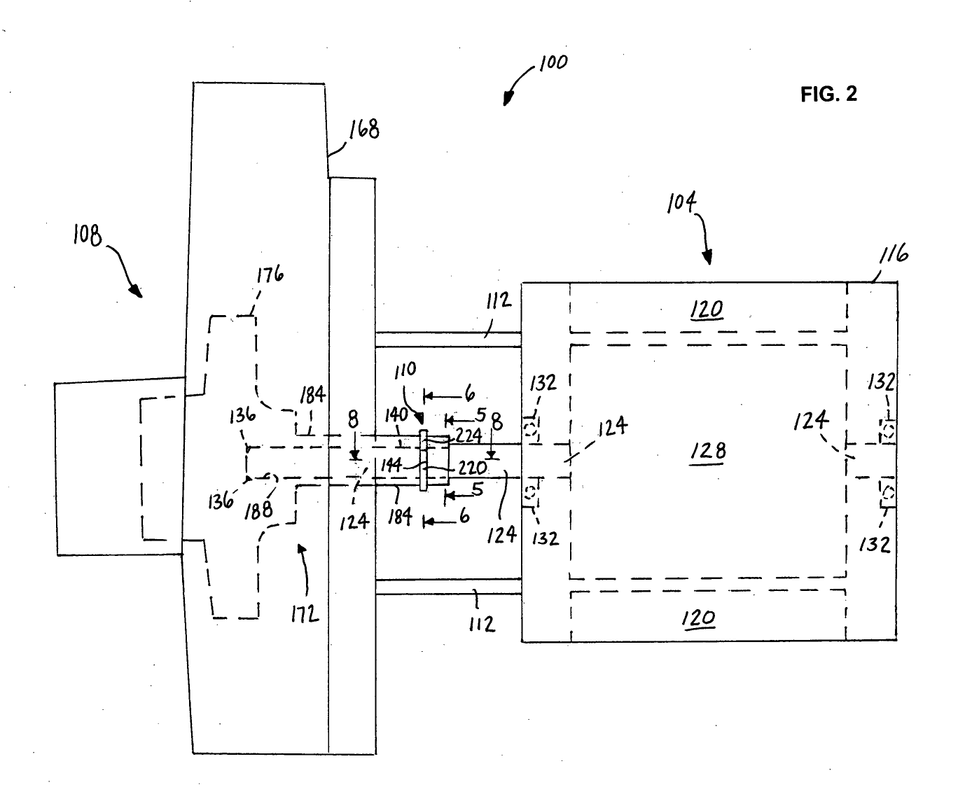

As schematically illustrated in FIG. 2, the motor 104 includes a housing 116, a stator 120 fixed relative to the housing 116, a shaft 124 rotatable relative to the housing 116 about a shaft axis, and a rotor 128 connected to the shaft 124 for rotation therewith relative to the stator 120. The shaft 124 extends from the housing 116 for connection to the load 108, as discussed further below. The shaft 124 is fully supported by bearings 132, thereby allowing the shaft 124, and the rotor 128 which is connected to the shaft 124, to rotate about the shaft axis.

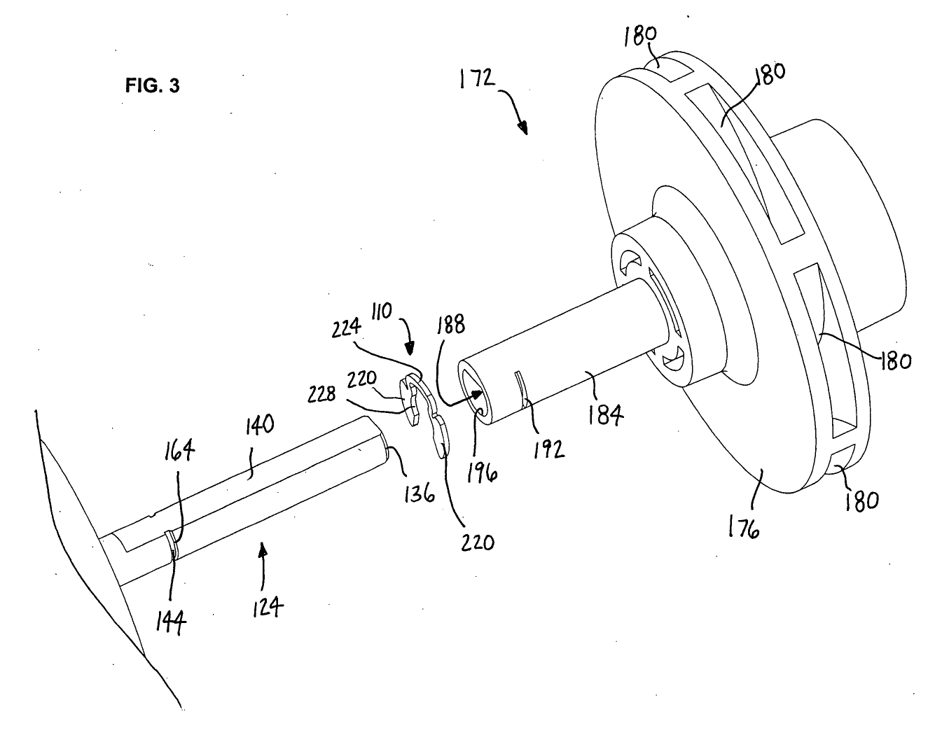

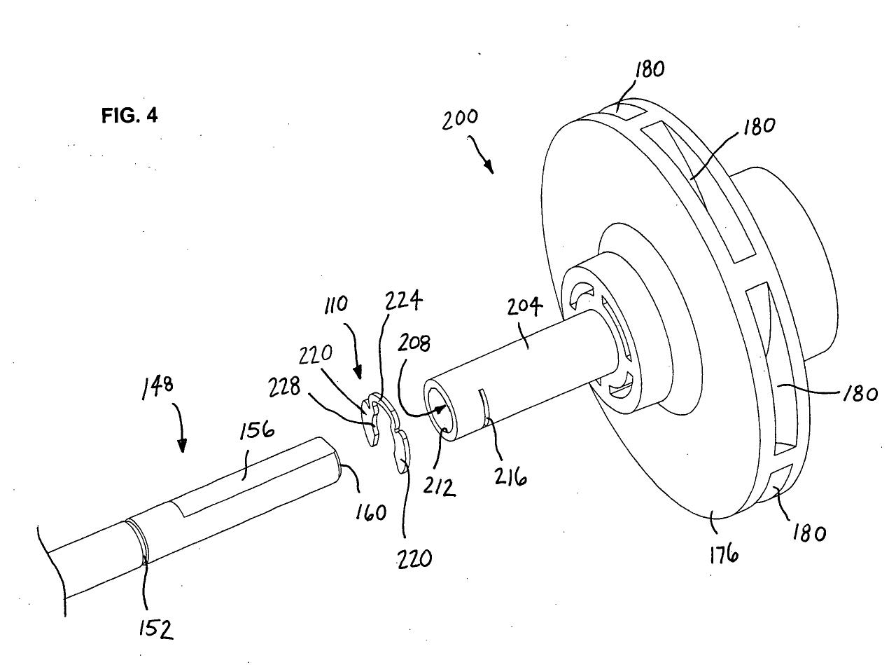

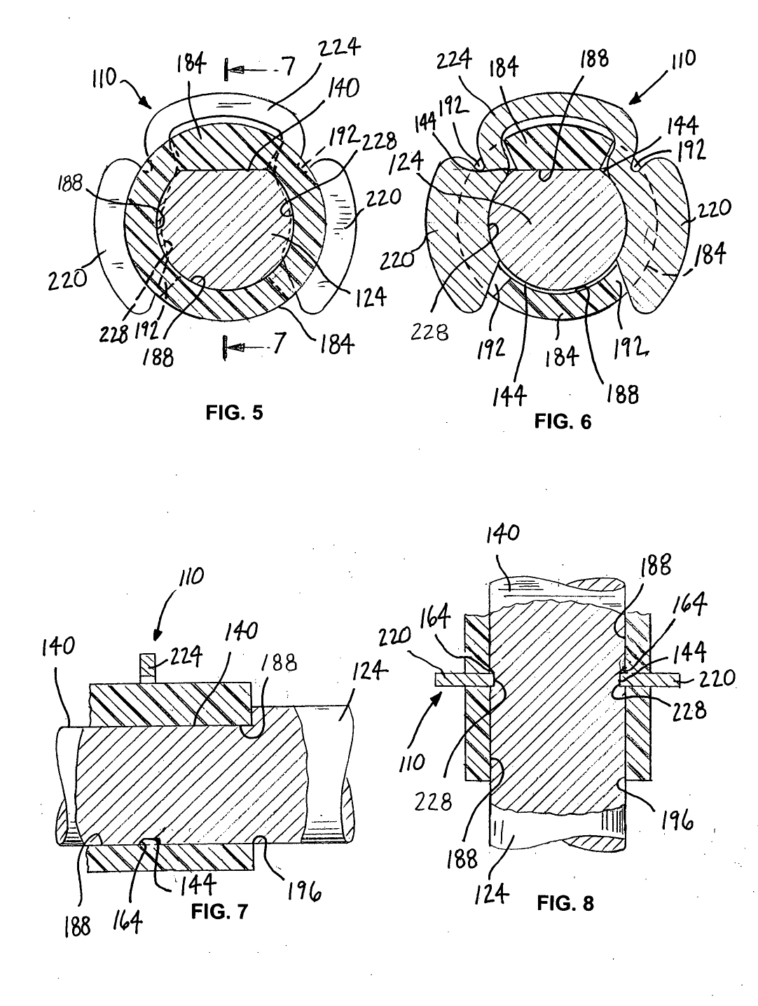

With reference to FIG. 3, the shaft 124 includes a chamfered end 136, a flat 140, and a groove 144. At least a portion of the shaft 124 comprises a cross-section that is non-circular (defined in a direction that is substantially normal to the shaft axis). In the illustrated construction, as best shown in FIGS. 5 and 6, the non-circular cross-section includes a sectional portion of the flat 140. In other constructions, shafts having portions that define other types of other non-circular cross-sections can be utilized. With continued reference to FIG. 3, the groove 144 is positioned on the portion of the shaft 124 that defines the flat 140. Accordingly, the groove 144 only circumferentially extends around a portion of the shaft 124. In other constructions, the groove 144 may be alternatively positioned and sized. For example, FIG. 4 illustrates a shaft 148 similar to the shaft 124 except the groove 152 is spaced from the portion of the shaft 148 that defines the flat 156 in a direction away from the chamfered end 160. In some constructions, as best illustrated in FIG. 7, the groove 144 can include a chamfered edge 164. With reference to FIGS. 7 and 8, the illustrated chamfered edge 164 extends from the groove 144 in a direction toward the chamfered end 136.

The shaft 124 also can also include a substantially axially facing surface (i.e., a surface that has an axial component that is normal to the shaft axis). In most constructions, the axial component of the surface is larger than the radial component of the surface. The substantially axially facing surface can include planar and/or curved portions. In the illustrated construction, as best illustrated in FIG. 7, the groove 144 defines two substantially axial facing surfaces. A first substantially axially facing surface extending radially outward from the bottom of the groove 144 and being completely axially facing, and a second substantially axially facing surface being defined by the chamfered edge 164 of the groove 144. In other constructions, substantially axially facing surfaces can be alternatively defined in the shaft. For example, the substantially axially facing surface can extend circumferentially around the entire shaft 124 or only a portion thereof.

With reference to FIG. 2, the load 108 includes a housing 168, which can comprise a number of separable portions, and a rotating member 172 configured to be driven by the motor 104 for rotation relative to the housing 168. The illustrated load 108 is a fluid pump and the illustrated rotating member 172 is an impeller (e.g., a molded plastic impeller) As the impeller 172 rotates relative to the housing 168, fluid is pumped in an inlet defined in the housing 168 and out an outlet defined in the housing 168. The fluid pump 108 can be used, for example, for pumping fluid through fluid jets in a hydromassage bathtub, a spa, a swimming pool, and the like.

With reference to FIG. 3, the impeller 172 includes a circular plate 176 having fins or vanes 180 defined therein. The impeller 172 also includes a hub having a hollow shaft 184 extending from the circular plate 176. The hollow shaft 184 defines a bore 188 and apertures 192 in communication with the bore 188. At least a portion of the bore 188 comprises a non-circular cross-section that corresponds to the non-circular cross-section of the portion of the shaft 124 that defines the flat 140. In the illustrated construction, as best shown in FIG. 5, the non-circular cross-section of the bore 188 exactly corresponds to the non-circular cross-section of the shaft 124. In other constructions, the non-circular cross-section of the bore 188 may only correspond to a portion of the non-circular cross-section of the shaft 124. Engagement between the non-circular cross-sections is intended to prevent rotation of the shaft 124 relative to the impeller 172. The degree of engagement between the bore 188 and the shaft 124 may be dependent on the torque requirements of the application.

With continued reference to FIG. 3, the non-circular cross section of the bore 188 begins at the opening 196 of the bore 188 and extends in a direction toward the circular plate 176. In other constructions, the non-circular cross-section of the bore 188 may be alternatively positioned to correspond to the shaft. For example, FIG. 4 illustrates an impeller 200 that defines a hollow shaft 204 having a bore 208 that includes a circular cross-section at the opening 212 to accommodate the shaft 148. The non-circular cross-section is spaced from the opening 212 to allow insertion of the shaft 148 into the bore 208 so the groove 152 can be substantially axially aligned with the apertures 216 in communication with the bore 208. The opening 196 of the bore 188 is surrounded by a continuous portion of the hollow shaft 184. Such definition of the bore 188 ensures the shaft 124 is supported by the bore 188 during operation of the assembly 100 in applications with various torque requirements.

With reference to FIGS. 3 and 6, each aperture 192 extends circumferentially around less than half of the hollow shaft 184. In other constructions, the hollow shaft 184 can define more than two apertures 192 in communication with the bore.

With reference to FIG. 3, the retainer 110 includes a pair of arms 220 spaced by a connecting portion 224. Each arm 220 includes an inner edge 228 curved to fit the bottom of the groove 144. In the illustrated construction, the retainer 110 is formed of metal. In other constructions, the retainer 110 can be alternatively sized and/or formed. The retainer 110 is configured to prevent axial movement of the shaft 124 relative to the impeller 172 during operation of the assembly 100. For assembly, the shaft 124 is inserted until the groove 144 is at least partially axially aligned with the apertures 192. The retainer 110 is then connected to the hollow shaft 184 and the shaft 124 by inserting the inner edge 228 of each arm 220 through a respective aperture 192 to engage the groove 144. The connecting portion 224 provides some resiliency to the retainer 110 which allows the arms 220 to flex outward and past the portion of the hollow shaft 184 adjacent the apertures 192 and then at least partially return to their pre-deformed position to extend through the apertures 192 so the inner edges 228 engage the groove 144. The chamfered edge 164 provides a ramp to the bottom of the groove 144 (see FIGS. 5, 6, and 8 which show the arms 220 positioned in the groove 144 and the inner edges 228 positioned in the bottom of the groove 144) if the groove 144 is not entirely axially aligned with the apertures 192.

Engagement of the axial surfaces of the arms 220 by the axially facing surfaces of the groove 144 prevents axial movement of the shaft 124 relative to the impeller 172 during operation of the assembly 100. Further, as discussed above, engagement of the flat 140 and the correspondingly shaped bore 188 prevents rotation of the shaft relative to the impeller.

The impeller 172 may be removed from the shaft 124 (e.g., for maintenance and/or replacement of either the motor 104 or the load 108) by removing the retainer 110 and axially moving at least one of the load 108 and the motor 104 relative to the other. Assemblies such as the assembly 100 provide access to the retainer 110 for assembly and disassembly. In other constructions, as discussed further below, the retainer may not be accessible.

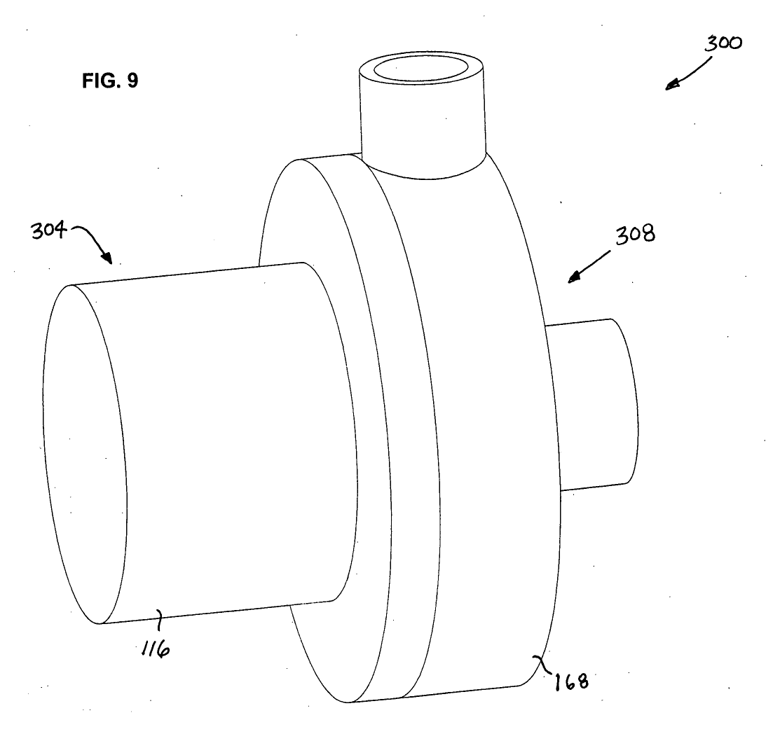

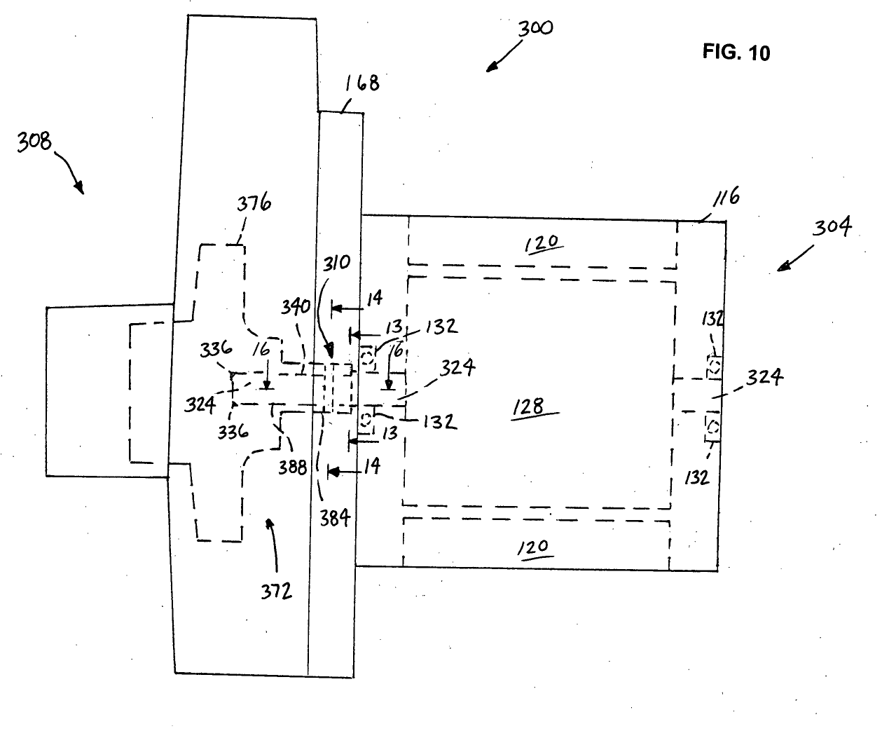

An assembly 300 according to a second construction of the invention is illustrated in FIG. 9-11 and 13-16. The assembly 300 has similarities with the assembly 100 and accordingly, only the differences between the two assemblies 100 and 300 are discussed herein. Components of the assembly 300 that are similar to the components of the assembly 100 are indicated using like numerals throughout the specification and the drawings. It should be understood that the invention is capable of use on other assemblies and the assemblies 100 and 300 are merely shown and described as two such examples.

With reference to FIG. 9, the assembly 300 includes an electric motor 304, a load 308, and a retainer or lock member 310 for use in drivingly connected the motor 304 to the load 308. As illustrated in FIG. 9, the motor 304 abuts the load 308, as is typical for heavy duty pump assemblies.

With reference to FIG. 11, the shaft 324 of the motor 304 includes a chamfered end 336, a flat 340, and a groove 344. The groove 344 can include a chamfered edge 364 that extends from the groove 344 in a direction toward the chamfered end 336. With reference to FIG. 15, the chamfered edge 364 does not extend to the bottom of the groove 344 as does the chamfered edge 164 in groove 144 (see FIG. 7). The groove 344 defines three axial facing surfaces. A first axially facing surface extends radially outward from the bottom of the groove 344 and is completely axially facing, a second axially facing surface extends radially outward from the bottom of the groove 344 to the chamfered edge 364 and is completely axially facing, and a third axially facing surface is defined by the chamfered edge 364 of the groove 344.

With reference to FIG. 11, the rotating member 372 is similar to the rotating member 172 except the hollow shaft 384 also defines a groove 394 that extends circumferentially around the hollow shaft 384. The apertures 392 extend through the groove 394 and communicate with the bore 388.

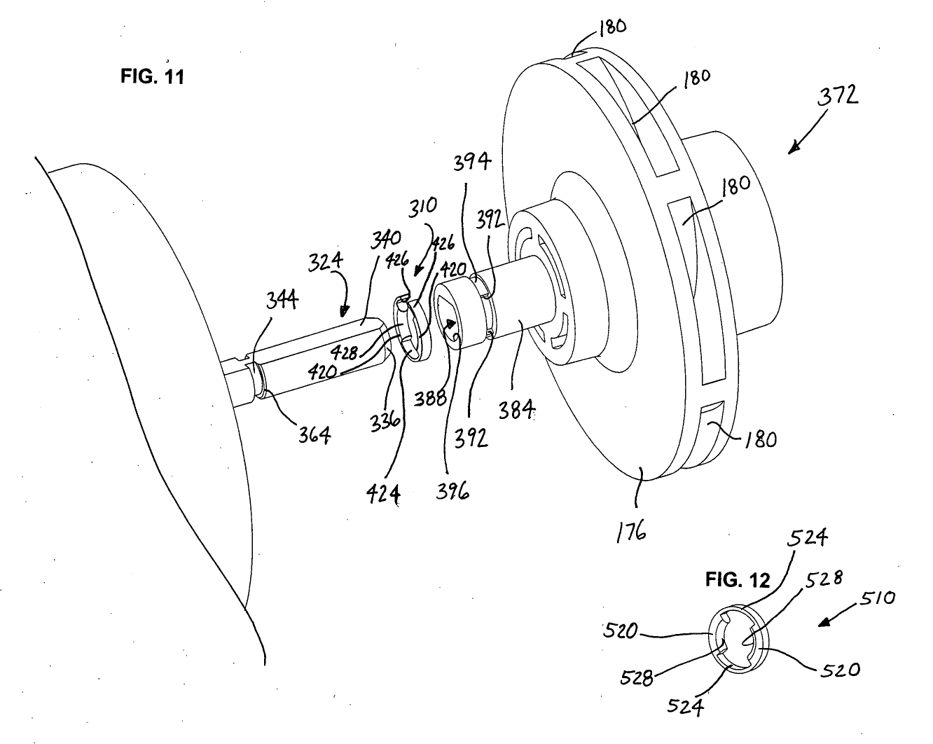

With reference to FIG. 11, the retainer 310 is partially O-shaped and includes a pair of tabs 420 spaced by a connecting portion 424 and a projection 426 extending from each tab 420 in a direction opposite the connecting portion 424. Each tab 420 includes an inner edge 428 curved to fit the bottom of the groove 344. With reference to FIG. 16, the inner edge 428 is rounded to ease assembly and disassembly. Further, the connecting portion 420 and each projection 426 includes an inner surface sized to engage the groove 394. In the illustrated construction, the retainer 310 is formed of a hard plastic material. In other constructions, the retainer can be alternatively sized and formed. For example, FIG. 12 illustrates a retainer 510 that is similar to the retainer 310 except the retainer is fully O-shaped instead of partially O-shaped. The retainer includes a pair of tabs 520 spaced by first and second connecting portions 524. Each tab 520 has an inner surface 528 similar to the inner surfaces 428. The retainer 510 can be formed of an elastomeric material to facilitate connection to the shaft 324 and the impeller 372.

The retainer 310 is configured to prevent axial movement of the shaft 324 relative to the impeller 372 during operation of the assembly 300. The retainer 310 can be inserted through the apertures 392 before or after insertion of the shaft 324 into the bore 388. However, when used in an assembly similar to the assembly 300 (i.e., an assembly where the retainer is not accessible during operation of the assembly), the retainer 310 is inserted through the apertures 392 before insertion of the shaft 324 into the bore 388.

For such assembly, a portion of the housing 168 can be connected to the motor housing 116 such that the shaft 324 extends into the portion of the housing 168. The retainer 310 is then connected to the hollow shaft 384 such that the inner edges 428 extend into the bore 388. Similar to the connecting portion 224 of the retainer 110, the connecting portion 424 provides some resiliency to the retainer 310 which allows the tabs 420 and the projections 426 to flex outward and past the portion of the hollow shaft 384 adjacent the apertures. The inner edges 428 then at least partially return to their pre-deformed position to extend through the apertures 392 and into the bore 388. Further, the connecting portion 424 and the projections 426 are received in the groove 394. The projections 426 serve to help secure the retainer 310 to the hollow shaft 384.

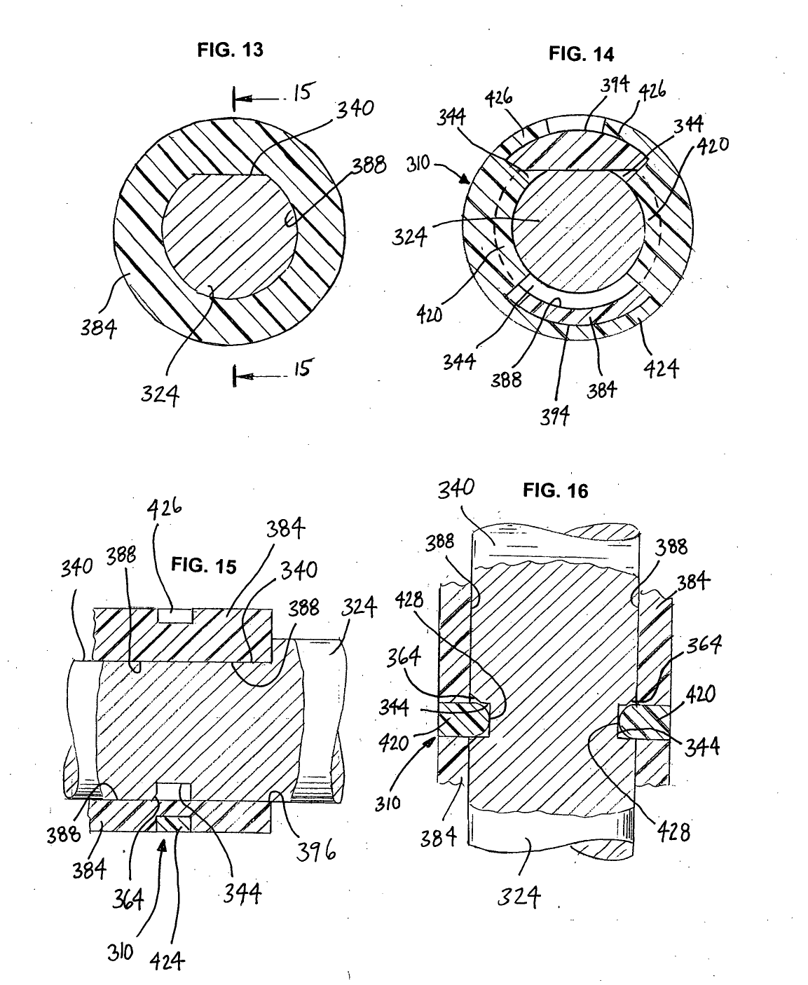

As best illustrated in FIGS. 13-16, the retainer 310 includes an outer diameter similar to the outer diameter of the hollow shaft 384. Accordingly, when the retainer 310 is seated in the groove 394, the hollow shaft 384 includes a fairly consistent outer surface (with the exception of the gap formed between the projections 426 of the retainer 310 as best shown in FIG. 14).

Once the retainer 310 is connected to the hollow shaft 384, the impeller 372 is moved axially relative to the shaft 324 with some force such that the chamfered end 336 causes the tabs 420 to deflect outward and ride along the outer surface of the shaft 324 until the inner edges 428 engage the chamfered edge 364. The chamfered edge 364 then provides a ramp to the bottom of the groove 344 (see FIGS. 14, 15, and 16 which show the tabs 420 positioned in the groove 344 with the inner edges 228 positioned against the bottom of the groove 344). Engagement of the axial surfaces of the tabs 420 by the axially facing surfaces of the groove 344 prevents axial movement of the shaft 324 relative to the impeller 372 during operation of the assembly 300. Further, engagement of the flat 340 and the correspondingly shaped bore 388 prevents rotation of the shaft relative to the impeller.

Once the impeller 372 is attached to the shaft 324, the remaining portions of the housing 168 may be assembled. The impeller 372 may be removed from the shaft for maintenance and/or removal by removing the necessary portions of the housing 168 and then applying an axial force sufficient to cause the inner edges 428 to ride up the chamfered edge 364 such that at least one of the load 308 and the motor 304 can be axially moved relative to the other. In other constructions, the retainer 310 may be accessible for assembly and disassembly.

The constructions described above and illustrated in the figures are presented by way of example only and are not intended as a limitation upon the concepts and principles of the invention. As such, it will be appreciated by one having ordinary skill in the art that various changes in the elements and their configuration and arrangement are possible without departing from the spirit and scope of the invention as set forth in the appended claims.

1. An assembly comprising:
an electric motor comprising
a first housing,
a stator fixed relative to the first housing,
a shaft supported by the first housing for rotation about a shaft axis, the shaft extending from the first housing, a portion of the shaft defining a first cross-section, the first cross-section being non-circular and substantially normal to the shaft axis, and
a rotor connected to the shaft for rotation with the shaft relative to the stator;
a load comprising
a second housing,
a rotating member configured to be driven by the electric motor for rotation relative to the second housing, the rotating member defining a bore and first and second apertures in communication with the bore, the bore being configured to receive at least a portion of the shaft, an opening of the bore being fully enclosed by a continuous portion of the rotating member, a portion of the bore defining a second cross-section, the second cross-section being non-circular and corresponding to at least a portion of the first cross-section; and
a retainer extending through the first and second apertures and engaging the shaft, the retainer substantially preventing axial movement of the shaft relative to the rotating member during normal operation of the electric motor.

2. An assembly as claimed in claim 1 wherein the load is a fluid pump, and wherein the rotating member is an impeller.

3. An assembly as claimed in claim 2 wherein the impeller is a molded plastic component.

4. An assembly as claimed in claim 1 wherein an end portion of the shaft is chamfered for guiding the shaft into the bore.

5. An assembly as claimed in claim 1 wherein the shaft comprises a shaft flat, and wherein the first cross-section comprises a sectional portion of the shaft flat.

6. An assembly as claimed in claim 1 wherein the shaft defines a surface having a substantially axially facing component, and wherein the retainer extends through the first and second apertures and engages the surface.

7. An assembly as claimed in claim 6 wherein the shaft defines a groove extending circumferentially around at least a portion of the shaft, wherein a portion of the groove is chamfered for guiding the retainer in to and out of the groove, and wherein the groove comprises the surface.

8. An assembly as claimed in claim 1 wherein the retainer comprises a C-shaped retaining ring, and wherein the C-shaped retaining ring is formed of metal.

9. An assembly as claimed in claim 1 wherein the retainer comprises an O-shaped retaining ring, and wherein the O-shaped retaining ring is formed of a elastomeric material.

10. An assembly as claimed in claim 1 wherein the retainer comprises a partially O-shaped retaining ring, and wherein the partially O-shaped retaining ring is formed of a plastic material.

11. An assembly as claimed in claim 1 wherein the portion of the bore defining the second cross-section comprises a sectional portion of the opening of the bore.

12. An assembly as claimed in claim 1 wherein the rotating member defines a groove, wherein the first and second apertures are in communication with the groove, and wherein the groove is sized to receive a portion of the retainer.

13. A method of drivingly connecting an electric motor to a rotating member, the method comprising:
providing an electric motor comprising
a stator,
a shaft supported for rotation about a shaft axis, a portion of the shaft defining a first cross-section, the first cross-section being non-circular and substantially normal to the shaft axis, the shaft defining a groove, and
a rotor connected to the shaft for rotation with the shaft relative to the stator;
providing a rotating member configured to be driven by the electric motor, the rotating member defining a bore and first and second apertures in communication with the bore, the bore being configured to receive at least a portion of the shaft, an opening of the bore being fully enclosed by a continuous portion of the rotating member, a portion of the bore defining a second cross-section, the second cross-section being non-circular and configured to engage at least a portion of the shaft that defines the first cross-section;
inserting the shaft into the bore so the groove is at least partially axially aligned with the first and second apertures;
providing a resilient lock member; and
deflecting the resilient lock member relative to the rotating member so the resilient lock member engages the groove through the first and second apertures.

14. A method as claimed in claim 13 and further comprising inserting the lock member through the first and second apertures prior to inserting the shaft into the bore, and wherein inserting the shaft into the bore comprises moving at least one of the rotating member and the shaft axially so the lock member deflects relative to the shaft and then engages the groove through the first and second apertures.

15. An assembly comprising:
an electric motor comprising
a first housing,
a stator fixed relative to the first housing,
a motor shaft supported by the first housing for rotation about a shaft axis, the motor shaft extending from the first housing, a portion of the motor shaft defining a first cross-section, the first cross-section being non-circular and substantially normal to the shaft axis, the motor shaft defining a groove; and
a rotor connected to the motor shaft for rotation with the motor shaft relative to the stator;
a fluid pump comprising
a second housing,
a molded plastic impeller configured to be driven by the electric motor for rotation relative to the second housing, the impeller comprising a hollow shaft, the hollow shaft defining a bore and first and second apertures in communication with the bore, the bore being configured to receive at least a portion of the motor shaft, an opening of the bore being fully enclosed by a continuous portion of the hollow shaft, a portion of the bore defining a second cross-section, the second cross-section being non-circular, the portion of the bore defining the second cross-section configured to engage at least a portion of the motor shaft that defines the first cross-section; and
a retaining member extending through the first and second apertures and engaging the groove, the retaining member substantially preventing axial movement of the motor shaft relative to the hollow shaft during normal operation of the electric motor.

16. An assembly as claimed in claim 15 wherein an end portion of the shaft is chamfered for guiding the shaft into the bore, and wherein a portion of the groove is chamfered for guiding the retaining member in to and out of the groove.

17. An assembly as claimed in claim 15 wherein the hollow shaft defines a second groove, wherein the first and second apertures are in communication with the second groove, and wherein the second groove is sized to receive a portion of the retaining member.

18. An assembly as claimed in claim 17 wherein the retaining member comprises a retaining ring, and wherein the retaining ring is at least partially O-shaped.

19. An assembly as claimed in claim 15 wherein the retaining member is disposed in the second housing during normal operation of the fluid pump.
